(19) United States
(12) Patent Application Publication
(10) Pub. No.: US 2004/0200926 A1
(43) Pub. Date: Oct. 14, 2004

(54) Seat locking mechanisms

(76) Inventors: Jochem Wilhelm Wodak, Denton, TX (US); Tak-Fu Cheung, Lewisville, TX (US); Will Leroy Andrews, Gainesville, TX (US)

Correspondence Address: JOHN S. PRATT, ESQ, KILPATRICK STOCKTON, LLP, 1100 PEACHTREE STREET, ATLANTA, GA, 30309, US

(21) Appl. No.: 10/396,994

(22) Filed: Mar. 25, 2003

(51) Int. Cl. B64C 27/22

(52) U.S. Cl. 244/10

(57) ABSTRACT

Locking mechanisms for backrest portions of (typically vehicle) seats are detailed. The mechanisms avoid any need to use conventional recline locks and thus simplify the designs of existing seats otherwise so equipped. The mechanisms also permit adjustment of the positions of the backrests relative to the bases prior to deployment and allow for tolerances as well.

### FIELD OF THE INVENTION

This invention relates to locking mechanisms for seats and more particularly (although not exclusively) to assemblies for preventing backs of vehicle seats from reclining.

### BACKGROUND OF THE INVENTION

U.S. Pat. No. 5,133,587 to Hadden, Jr., incorporated herein in its entirety by this reference, discusses certain conventional vehicle seats. The seats include “upper pivotable back portions” and “lower stationary seating portions” attached together using pivot bolts. Typically by depressing buttons in armrests of the seats, users may actuate hydrolock mechanisms and cause the back portions to pivot between upright and various reclined positions.

U.S. Pat. No. 6,328,382 to Yawashita, likewise incorporated herein in its entirety by this reference, details a locking structure for a reclinable seat. The seat includes a back and a base (denominated a “cushion”), each having a bracket secured to it. A pair of lock gears is interposed between the brackets and operated by a rotatable cam when a passenger moves a lever or handle.

Common carriers, such as passenger airlines, bus lines, and train lines, frequently convey substantial numbers of passengers simultaneously. Fleet vehicles of these carriers thus typically contain multiple passenger seats, some or many of which, like the seats of the Hadden, Jr. and Yawashita patents, are adapted to recline. Moreover, in a particular accommodation class within a passenger vehicle, carriers often strive for uniformity of seating for reasons of cost, safety, aesthetics, and fairness. In many instances, therefore, standard seats produced for common carriers usually are designed to be reclinable upon passenger demand.

Notwithstanding the foregoing, however, some seats within certain vehicles advantageously do not recline. One example of such seats are those in rows of seating immediately forward of commercial aircraft exits. If these seats could recline, then seatbacks could impede passengers from escaping from aircraft exits during emergencies. Similarly, seats positioned immediately forward of bulkheads, galleys, lavatories, or other parts of commercial vehicles need not recline. Other seats, while not having their backrests fixed in a fully-upright position, nevertheless beneficially may not permit customer adjustment in use.

### SUMMARY OF THE INVENTION

The present invention provides mechanisms for preventing vehicle seats from reclining. The mechanisms, further, simplify the designs of existing seats whose ability to recline has been inhibited, typically with devices known in the art as “recline locks” or “hydrolocks.” They thus provide relatively low-cost, low-maintenance alternatives to existing recline-impeding assemblies.

Preferred embodiments of the mechanisms of the present invention include a support back and retaining bushing forming an interface between the spreader assemblies (bases) and backrest portions of seats. Incorporated into support backs are serrations and slotted openings. Together with serrations present on the bushings, the serrations and slots of the support backs permit initial adjustment of the positions of the backrests relative to the bases (and allow for tolerances as well). Stated differently, the backrests may be locked in positions other than fully upright prior to deployment in vehicles.

It thus is an optional, non-exclusive object of the present invention to provide seats including recline-inhibiting mechanisms.

It is an additional optional, non-exclusive object of the present invention to provide vehicle seats whose backrest portions are fixed relative to the bases after deployment in vehicles.

It is a further optional, non-exclusive object of the present invention to provide seats omitting conventional recline locks (or hydrolocks) in favor of simplified designs.

It is also an optional, non-exclusive object of the present invention to provide seat-locking mechanisms including support backs and bushings.

It is another optional, non-exclusive object of the present invention to provide seats in which slots and serrations in support backs or bushings permit adjustment (and allow for tolerances) prior to deployment.

Other objects, features, and advantages of the present invention will be apparent to those skilled in the relevant fields with reference to the remaining text and drawings of this application.

### BRIEF DESCRIPTION OF THE DRAWINGS

FIG. 1 is a perspective view of a (nominally) interior face of an exemplary support back of the present invention.

FIG. 2 is a perspective view of a (nominally) exterior face of the support back of FIG. 1.

FIG. 3 is a perspective view of an exemplary bushing of the present invention.

FIG. 4 illustrates the support back of FIG. 1 attached to a seat.

FIG. 5 illustrates the support back of FIG. 1 and the bushing of FIG. 3 attached to a seat.

### DETAILED DESCRIPTION

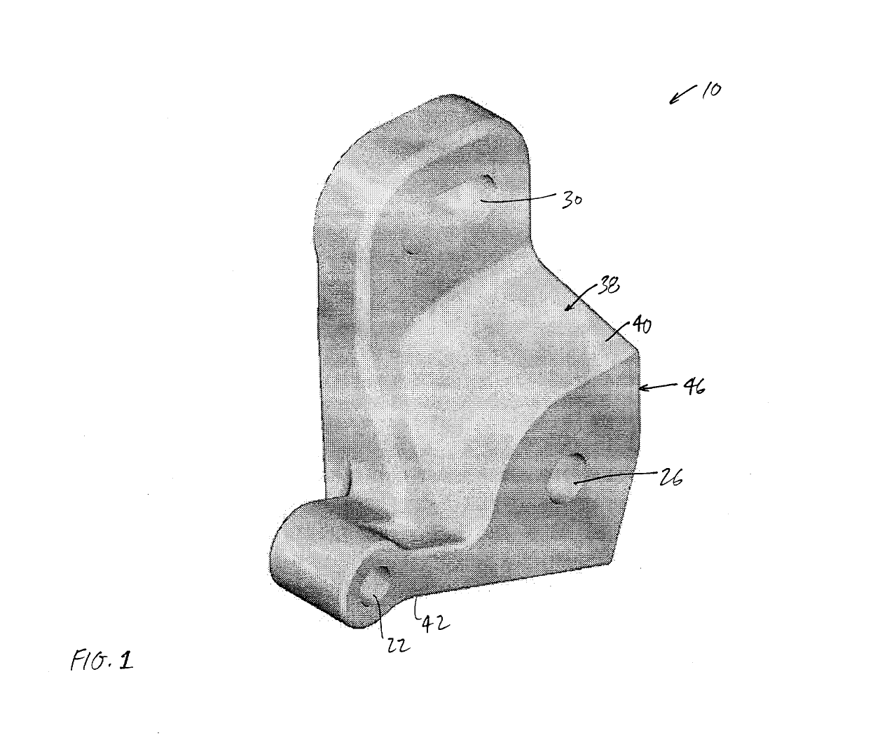

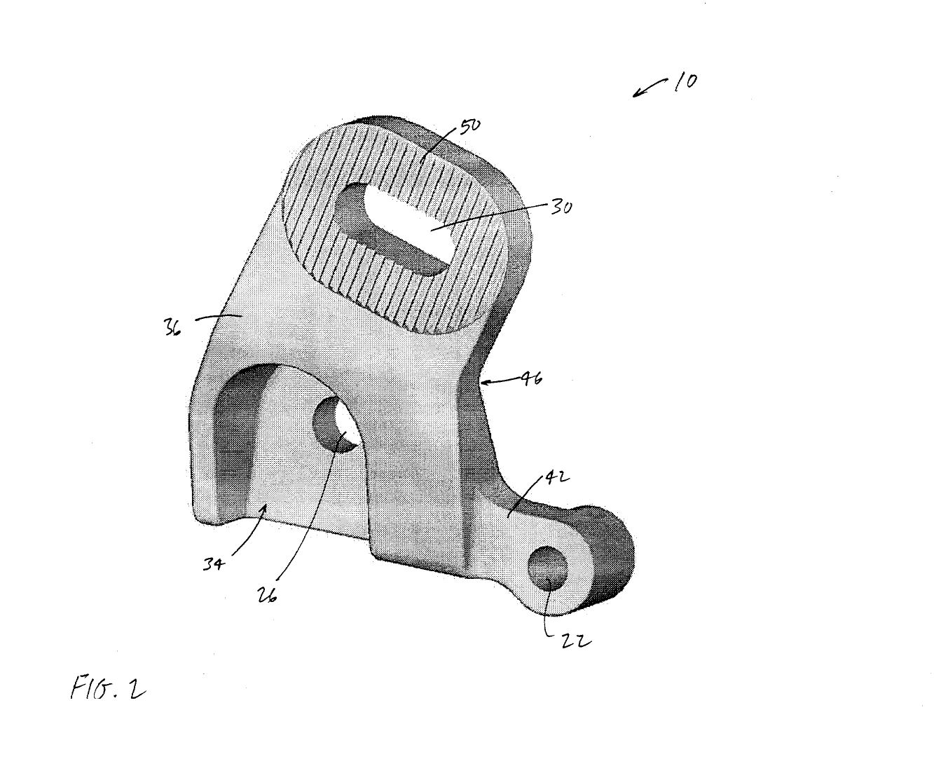

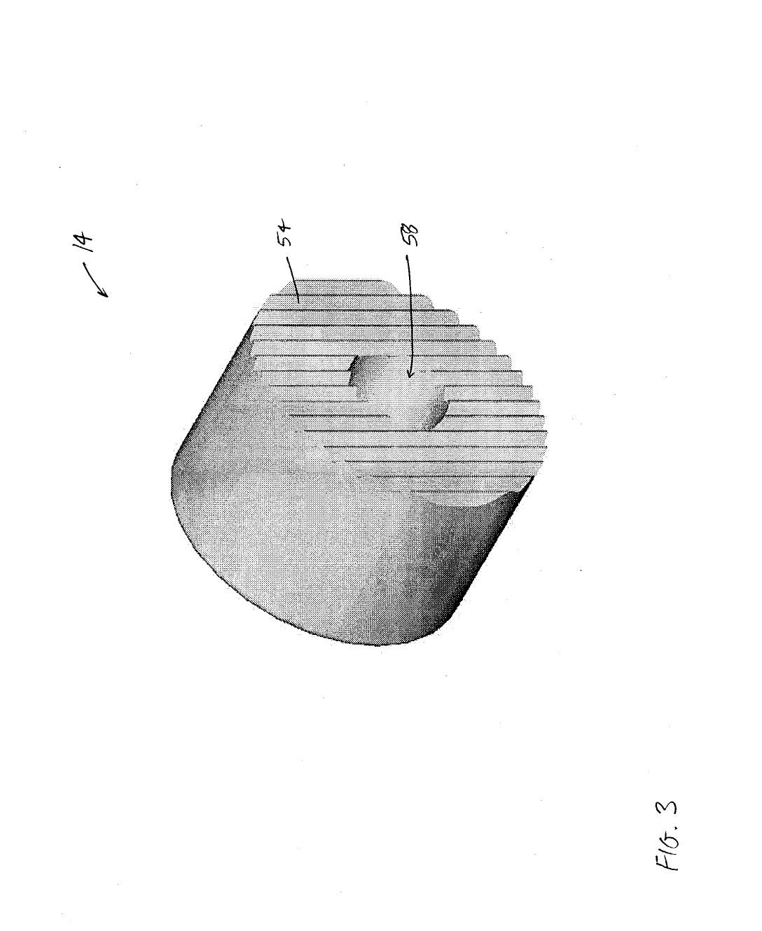

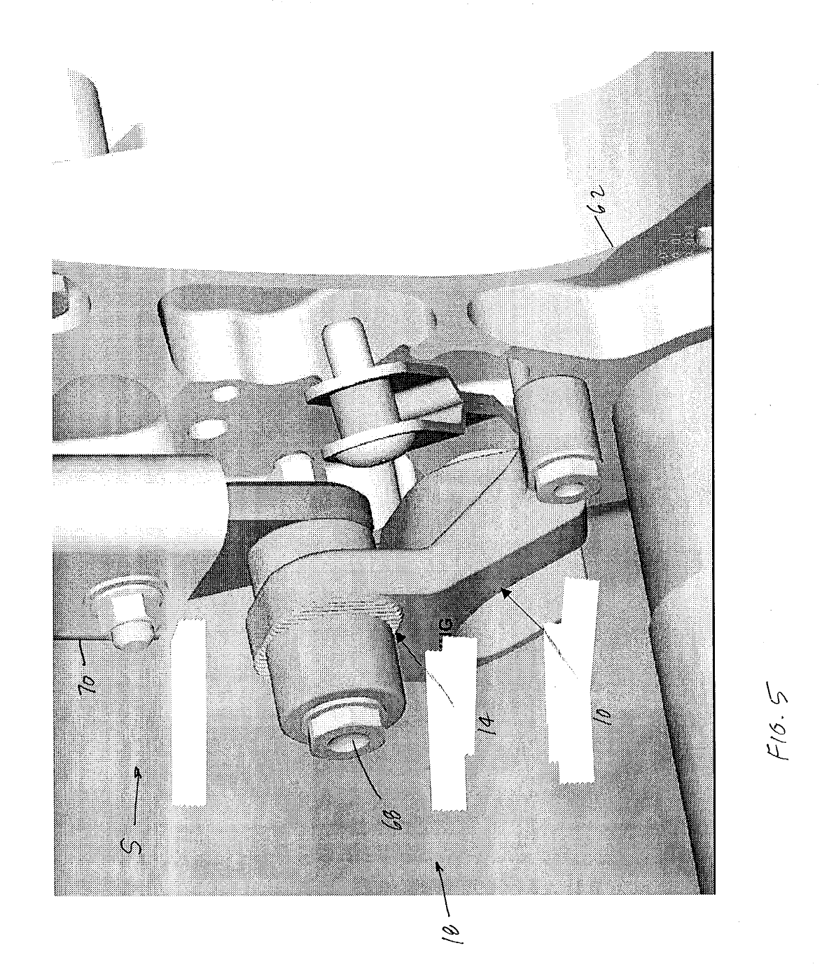

FIGS. 1-2 depict support back 10 of the present invention. Together with bushing 14 shown in FIG. 3 (and appropriate fasteners), support back 10 comprises a mechanism for fixing the position of the backrest portion of a seat relative to its base. Such mechanism (labelled 18) is illustrated in FIG. 5 installed in seat S, some of whose exterior components have been removed to facilitate viewing of its frame. One such seat S preferably is structured like that in FIGS. 1-3 of the Hadden, Jr. patent (albeit without need for the hydrolock depicted therein), although mechanism 18 alternatively may be used with other types of seats.

As detailed in FIGS. 1-2, support back 10 may be a cast, irregularly-shaped component, typically formed of metal or composite materials. Support back 10 contains multiple spaced openings 22, 26, and 30 adapted to receive bolts or other suitable fasteners. Openings 22 and 26 preferably have circular cross-section, while opening 30 preferably is elongated and thus in the nature of a slot (with generally elliptical cross-section). Support back 10 further may include recess 34 of exterior face 36, whose existence corresponds with shoulder 38 of interior face 40, and arm 42 formed with (or otherwise connected to) its main body 46.

Also depicted as included on exterior face 36 are serrations 50. Such serrations 50 are associated with elongated opening 30, although they need not necessarily uniformly surround the opening 30 as shown in FIG. 2. In use, serrations 50 engage corresponding serrations 54 of bushing 14 (FIG. 3), so that movement of support back 10 and bushing 14 cannot thereafter occur. Further, because serrations 50 surround the length of opening 30, bushing 14 may engage support back 10 anywhere in the serrated region, thus allowing its position relative to support back 10 to vary prior to tightening of the associated fastener. (Or, described differently, any fastener passing through opening 58 of bushing 14 need not pass through the center of elongated opening 30, but rather may pass through any portion of the opening 30.) This variable positioning allows the backrest to be reclined a selected amount before its position is fixed. Applicants note, however, that those skilled in the art will recognize that engagement mechanisms other than serrations 50 and 54 may be utilized instead yet achieve the desired results.

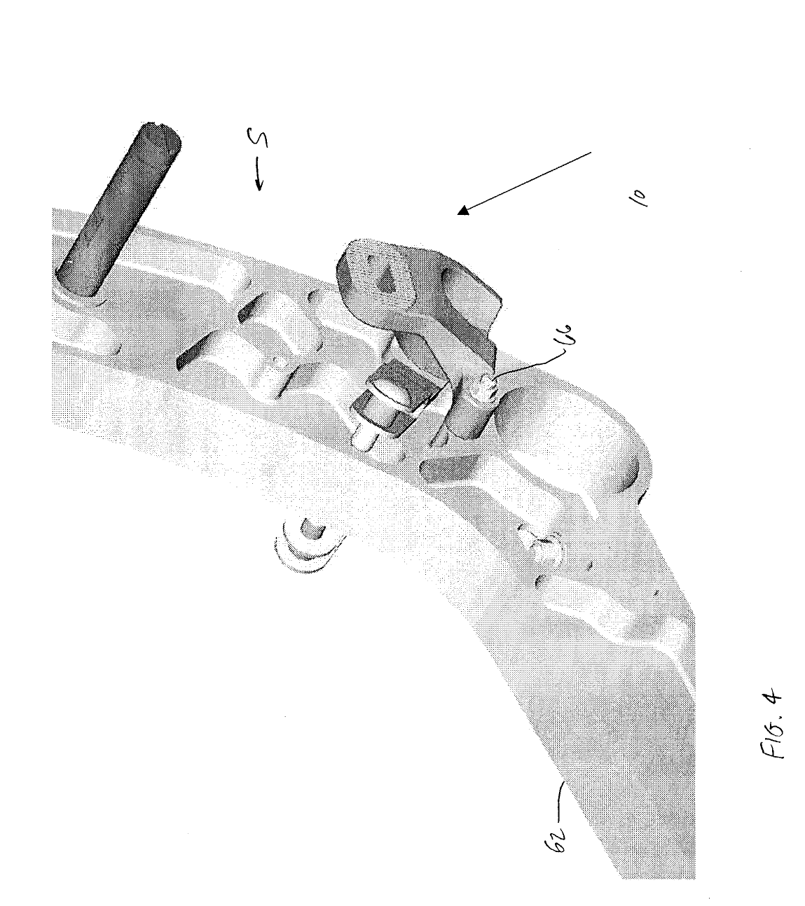

FIG. 4 illustrates support back 10 positioned for attachment to seat S. As shown in FIG. 4, connection of support back 10 to base 62 of seat S may occur by inserting bolt 66 or other appropriate fastener through opening 22 and an aligned opening of base 62. An additional fastener may be inserted through opening 26 for connection to a recessed portion of base 62. With support back 10 so connected, a bolt or part of another suitable fastening assembly 68 may be inserted through opening 58 of bushing 14, (elongated) opening 30 of support back 10, and through an aligned opening of backrest portion 70 of seat S. This connection, at the pivot axis of backrest portion 70, prevents portion 70 from pivoting following engagement of serrations 50 and 54 and tightening of the fastener.

If desired, an additional mechanism 18 may be connected similarly on the opposite side of seat S. Doing so distributes forces otherwise present solely on the mechanism 18 depicted in FIG. 5 and thus is preferred when mechanism 18 is used with a vehicle seat. Moreover, in certain situations mechanism 18 could be used together with a recline lock or hydrolock, although doing so is unnecessary in the context of the invention.

The foregoing is provided for purposes of illustrating, explaining, and describing exemplary embodiments and certain benefits of the present invention. Modifications and adaptations to the illustrated and described embodiments will be apparent to those skilled in the relevant art and may be made without departing from the scope or spirit of the invention.

What is claimed is:

1. A seat comprising:
a. a base portion;
b. a backrest portion connected directly or indirectly to the base portion; and
c. means, comprising a support back, for fixing the position of the backrest portion relative to the base portion.

2. A seat according to claim 1 in which the support back includes first and second openings.

3. A seat according to claim 1 further comprising:
a. a first fastener received by the first opening; and
b. a bushing including an opening adapted to receive the first fastener.

4. A seat according to claim 3 in which the first opening is elongated and may receive the first fastener at more than one position along its length.

5. A seat according to claim 4 in which each of the support back and bushing comprise features, the features of the bushing complementing those of the support back, so that the features of the bushing engage those of the support back when the first fastener is received by the first opening of the support back and the opening of the bushing.

6. A seat according to claim 5 in which the features of the support back and bushing are serrations.

7. A seat according to claim 6 further comprising a second fastener received by the second opening, for connecting the support back to the base portion.

8. An aircraft seat comprising:
a. a base portion;
b. a backrest portion connected directly or indirectly to the base portion; and
c. an interface for fixing the position of the backrest portion relative to the base portion, the interface comprising:
i. a support back having a serrated portion; and
ii. a bushing having a serrated portion, the bushing engaging the support back via the serrated portions when the bushing is fastened to the support back.

9. A seat according to claim 8 in which the support back includes a slot and the bushing includes an opening aligned with a portion of the slot when the bushing is fastened to the support back.

10. A seat comprising:
a. a base portion;
b. a backrest portion connected directly or indirectly to the base portion; and
c. means, omitting any recline lock, for fixing the position of the backrest portion relative to the base portion.

11. A seat according to claim 10 for use in a vehicle.

12. A seat according to claim 11 in which the vehicle is an aircraft.
